(19) United States
(12) Patent Application Publication
(10) Pub. No.: US 2018/0096566 A1
(43) Pub. Date: Apr. 5, 2018

(54) AUTOMATED POINT OF SALE SYSTEM

(71) Applicant: Wal-Mart Stores, Inc., Bentonville, AR (US)

(72) Inventors: Richard M. Blair, II, Bentonville, AR (US); Timothy Ryan Young, Bentonville, AR (US); William Ross Allen, Pea Ridge, AR (US)

(21) Appl. No.: 15/722,220

(22) Filed: Oct. 2, 2017

Related U.S. Application Data
(60) Provisional application No. 62/403,931, filed on Oct. 4, 2016.

(51) Int. Cl. G07G 1/00

(52) U.S. Cl. CPC G07G 1/0009; G07G 1/0054; G07G 1/009

(57) ABSTRACT

Systems, methods and devices for automating a point of sale within a physical location, such as a merchant or store. The point of sale system may automate a purchase transaction through a series of interactions between the customer's mobile communication device or other computer system and a store's computer network of camera systems, RFID devices and/or sensor devices monitoring product shelves. The store may use a computer system linked to the camera systems of the store to verify the identity of the customer, identify the customer's account with the particular store and verify items selected by the customer. The customer's computer system and the store's computer system may negotiate the sale based on the video data and RFID data to identify the products selected, calculate the total cost and finalize the transaction without performing employee assisted checkout or customer-based self-checkout.

### CROSS-REFERENCE TO RELATED APPLICATIONS

This application claims the benefit and priority of U.S. patent application Ser. No. 62/403,931, entitled AUTOMATED POINT OF SALE SYSTEM, filed on Oct. 4, 2016, the contents of which are hereby incorporated by reference.

### TECHNICAL FIELD

The present disclosure relates generally to point of sale systems, methods and apparatuses for automating identification, selection and purchases of products.

### BACKGROUND

In recent years, supermarkets, grocery stores, convenience stores and others have shifted a portion of the point of sale systems being utilized entirely from employee-operated systems to self-service check-out systems. Self-service type point of sale systems are generally operated by a purchaser himself to finalize the sale of purchased commercial products before exiting the store. These self-service point of sale systems were intended to provide additional options for customers seeking to purchase products increase the available number of point of sale systems operating simultaneously within a store and reduce the amount of time waiting in line. Each of the self-service systems may achieve such a result without having to significantly increase the number of employees assisting customers directly, at the point of sale.

While the self-service point of sale systems can be useful once implemented, the self-service point of sale systems suffers from some significant drawbacks. The self-service systems require users to manually operate the self-service hardware, scanners and payment processing machinery. The interfaces can be confusing to consumers and can result in numerous errors, increasing the overall time to complete the sale of the products and increase waiting times for the remaining customers. Removing the interaction between customer and the point of sale system, integrating the checkout process to operate automatically prior to the customer leaving the store, can eliminate checkout wait times and offer a seamless shopping experience. Thus there is a need for the automated point of sale system described in this application below.

### SUMMARY

A first embodiment of the present disclosure provides a method for automating a point of sale system product comprising the steps of: establishing, by a central processing unit (CPU) of a computer system, a connection between the computer system and a radio-frequency identification (RFID) device associated with the product; receiving, by the CPU, product data transmitted by RFID device; further receiving, by the CPU, visual verification data identifying a quantity of the product selected for the sale, the visual verification data being transmitted to the CPU by an object recognition camera; calculating, by the CPU, a total cost of the sale as a function of the product data and the quantity identified by the visual verification data; and billing, by the CPU, the total cost of the sale automatically to an account accessible by the computer system.

A second embodiment of the present disclosure provides an automated point of sale system comprising a computer system comprising a central processing unit (CPU), a memory device coupled to the CPU and a computer readable storage device coupled to the CPU; an object recognition camera system electronically communicating with the CPU; a radio-frequency identification (RFID) device electronically communicating with the CPU; and the computer readable storage comprises program code executable by the CPU via the memory device to implement a method for automating a sale of a product comprising the steps of: establishing, by the CPU, a connection between the computer system and the RFID device associated with the product; receiving, by the CPU, product data transmitted by RFID device; further receiving, by the CPU, visual verification data from the object recognition camera system identifying a quantity of the product selected for the sale; calculating, by the CPU, a total cost of the sale as a function of the product data and the quantity identified by the object recognition camera system; and billing, by the CPU, the total cost of the sale automatically to an account accessible by the computer system.

A third embodiment of the present disclosure provides a computer program product comprising: a computer-readable storage device; and a computer-readable program code stored in the computer-readable storage device, the computer-readable program code comprising instructions executed by a central processing unit (CPU) of a computer system implementing a method for automating a sale of a product comprising the steps of: establishing, by the CPU, a connection between the computer system and the RFID device associated with the product; receiving, by the CPU, product data transmitted by RFID device; further receiving, by the CPU, visual verification data from the object recognition camera system identifying a quantity of the product selected for the sale; calculating, by the CPU, a total cost of the sale as a function of the product data and the quantity identified by the object recognition camera system; and billing, by the CPU, the total cost of the sale automatically to an account accessible by the computer system.

### BRIEF DESCRIPTION OF THE DRAWINGS

FIG. 1 depicts a block diagram of an embodiment of a system for automating a sale of a product.

FIG. 2 depicts an embodiment of an algorithm for automating a sale of a product.

FIG. 3 depicts an embodiment of a continuation of the algorithm described in FIG. 2.

FIG. 4 depicts an alternative embodiment of a continuation of the algorithm described in FIG. 2.

FIG. 5 depicts a block diagram of a generic computer system for implementing the systems and methods consistent with the disclosure.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

### Overview

Embodiments of present disclosure automate, simplify and eliminate the waiting time between transactions, compared with existing point of sale systems, methods and apparatuses. The systems, methods and apparatuses described in the present disclosure improve upon standard employee-assisted point of sale systems and customer-based self-directed point of sale systems. Improvements to currently available systems are made by automating the transaction process, eliminating the need for either the employee or customer to complete the transaction in order for the transaction to be processed. Embodiments of the present disclosure allow for the point of sale system to achieve a seamless transition between product selection and product sale by leveraging a combination of hardware and software systems. Embodiments of the present disclosure may leverage computer systems, computer networks, radio frequency identification (RFID) devices, sensor technologies, camera systems and object recognition software to accurately assess product selection by the customer and accurately complete the sales transaction prior to the customer leaving the store's property.

The point of sale system may automate a purchase transaction through a series of interactions between the customer's mobile communication device or other computer system and a store computer system connected via a computer network to a camera system, RFID device and/or a sensor device. Embodiments of the system may utilize the customer's communication device to identify the device's current location, within, near or proximate to the store. As the customer interacts with one or more products being sold by the store, for example by picking up the item and/or placing the item in the customer's cart, an interaction between the customer's device and an RFID tag affixed to the products may occur. The customer's communication device may receive product information stored by the RFID tag, including the product name, cost, manufacturer and brief description.

In some embodiments of the point of sale system, the store may use a computer system linked to camera systems positioned within the interior or exterior of the store to confirm or verify the identity of the customer, identify the customer's account with the particular store and confirm the products selected by the customer for purchase. The camera systems may be equipped with facial recognition or biometric software to analyze and identify the customer. The camera systems may further utilize object recognition software to identify the products selected and removed from the store shelves by the customer. Embodiments of the store's computer system and the customer's mobile communication device may compare the RFID information with video data obtained by the camera system to determine the products selected for purchase by the customer. The customer's computer system and the store's computer system may negotiate the sale based on the video data, RFID data and the customer's location data to finalize the transaction. For example, as the customer leaves the store, the collected RFID data and video data may identify the products within the possession of the customer and in response to the RFID and video data, the computer system may calculate the total bill.

In some embodiments of the point of sale system, the store may further estimate the quantity and types of products selected by the customer through the use of sensor devices. Store shelves may be equipped with sensor devices placed in communication with the point of sale system. The sensor devices may monitor shelves assigned to a specific products, locations or displays. As the customer removes products from the shelves, the sensor assigned to the shelf or area of the store may detect a change in signal due to the removal of the product. For example, the use of a sensor device measuring the total weight currently on the shelf. As a product is removed, the weight will decrease, thus indicating a customer has selected a product. The change in the sensor signal may be communicated to the store's computer system or the customer's communication device. The camera system may subsequently verify the removal of the product from the store shelves in response to the change in the signal detected by the sensor.

Upon verification by the point of sale system that the customer has selected a product for purchase, the point of sale system may automatically tabulate the cost of the sale and request payment from the customer's communication device and/or account. The customer's communication device may accept the proposed bill automatically and provide payment information in order to finalize the transaction. The finalization of the transaction may be performed without the customer or an employee of the store manually attending to the transaction. Upon finalization of the sale, the customer may receive a copy of a sales receipt which may be transmitted to the customer's communication device and displayed accordingly. In some embodiments, the point of sale system may further transmit video verification data to the customer confirming the products selected from the store for purchase.

### System for Reordering a Consumable Product

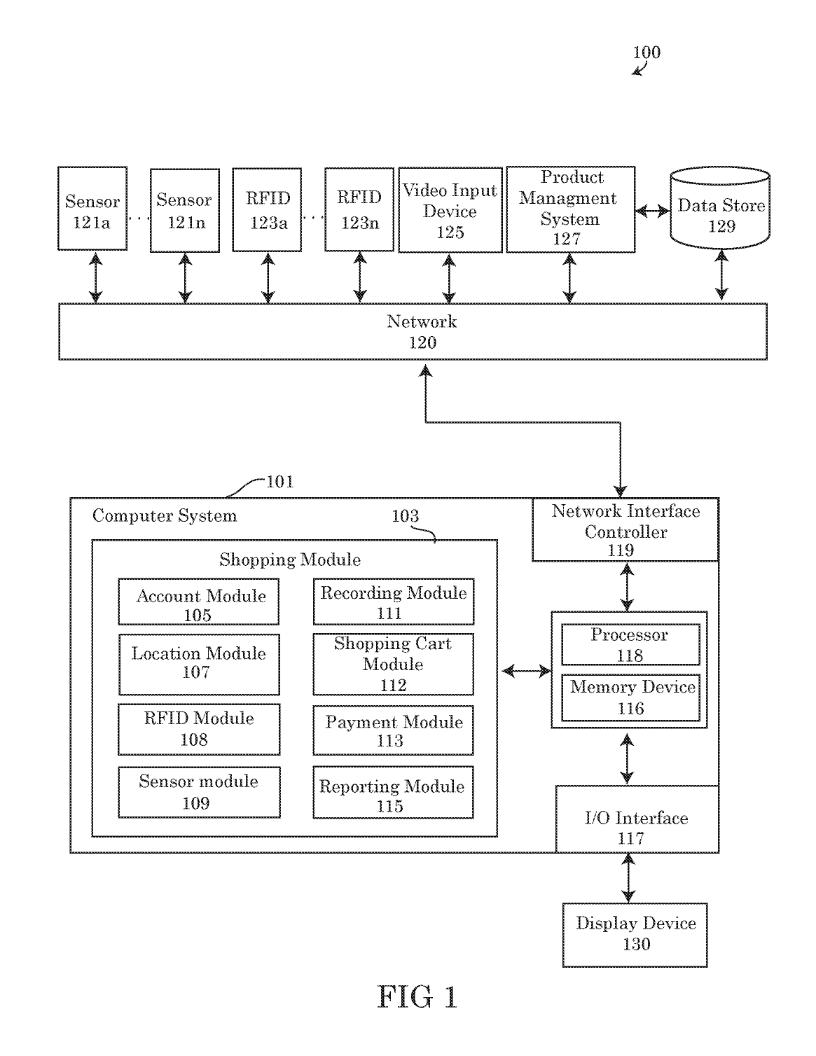

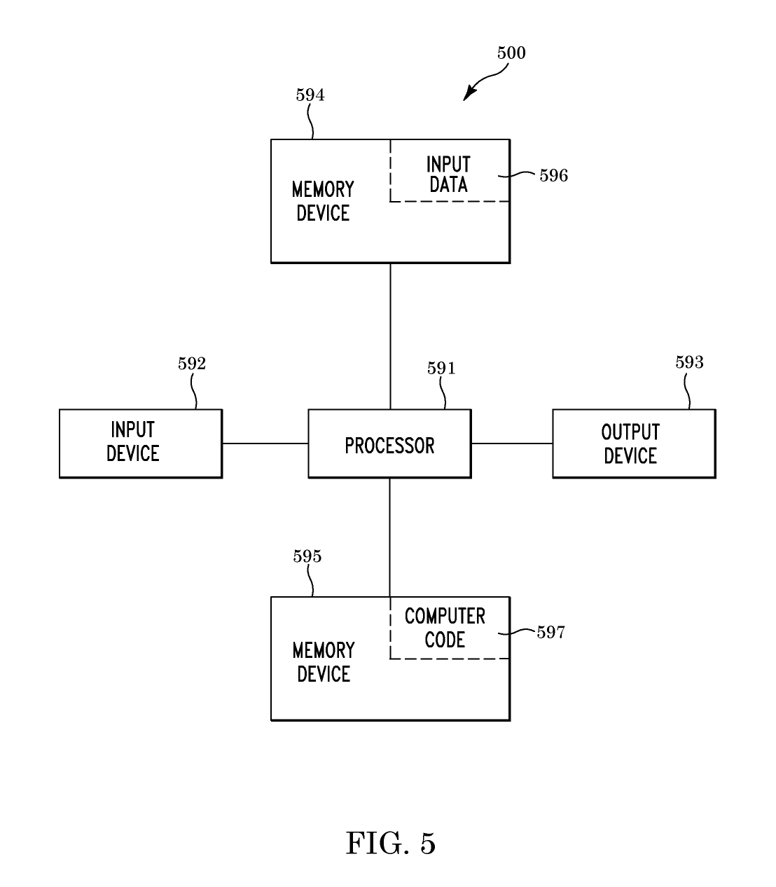

Referring to the drawings, FIG. 1 illustrates a block diagram of an automated point of sale system 100 (hereinafter “system 100”), capable of automating a sale of a product, consistent with the disclosure of this application. Embodiments of system 100 may comprise a computer system 101. The computer system 101 may be a specialized computer system, having specialized configurations of hardware, software or a combination thereof as depicted in FIG. 1 of the present disclosure. Embodiments of the computer system 101 may further comprise one or more elements of the generic computer system 500 of FIG. 5, described in detail below. The elements of the generic computer system 500 may be integrated into the specialized computer system 101 of FIG. 1.

Embodiments of the computer system 101 of system 100, may include a shopping module 103 accessed by the processor 118 to perform one or more functions or tasks of the shopping module which may be a central processing unit (CPU 591) in some embodiments. The term “module” may refer to a hardware module, software-based module or a module may be a combination of hardware and software resources of the computer system 101 and/or resources remotely accessible to computer system 101. A module, whether comprising hardware, software or a combination of resources thereof, may be designed to implement or execute one or more particular functions, tasks or routines of the point of sale system 100. Embodiments of hardware-based modules may include self-contained components such as chipsets, specialized circuitry and one or more memory devices. A software-based module may be part of a program code or linked to program code containing specific programmed instructions loaded into the memory device 116 of the computer system 101 and/or a remotely accessible memory device (not shown) such as a network accessible computer system, for example a web server, network server or application server. In the system 100, shown in FIG. 1, the network accessible computer system may include the product management system 127, which may be acting as a network server, web server or application server. Additional network computer systems may include RFID device 123, a sensor device comprising sensor 121 and a video input device 125. In some embodiments, the shopping module 103, as described in this application, may be partially or entirely incorporated into the product management system 127 or other computing device connected to the network 120. In such an embodiment, the computer system 101 may remotely access each of the features of the shopping module 103 performed by the product management system 127 or other computer device remotely via the network 120.

Embodiments of the shopping module 103 may include one or more sub-modules (either hardware or software based). Each sub-module of the shopping module 103 may be designated with performing one or more tasks or routines of the shopping module 103. In some embodiments of system 100, the shopping module 103 may include an account module 105, a location module 107, an RFID module 108, a sensor module 109, a recording module 111, a shopping cart module 112, a payment module 113 and/or a reporting module 115.

The account module 105 may perform one or more tasks related to identifying a user account, linking the user's account to system 100 and/or remotely accessing the user account, requesting, receiving and transmitting user information from stored by the user's account to the product management system 127. The account module 105 may be responsible for saving, storing and retrieving a user's account information (locally or via a network), configuration settings, identification information and payment information. Embodiments of the account module 105 may receive input data from the user, which may indicate the presence of one or more particular users accessing the system 100 via computer system 101 and in response to receiving the input data indicating the presence of a particular user, the account module 105 may select the appropriate user account and load the account information into the memory device 116 of the computer system 101.

Embodiments of the account module 105 may identify the user of the computer system 101 by verifying the authorization of the user attempting to access an account stored by the system 100. The account module 105 may access the user account from the computer system 101, data store 125, the product management system 127 or other network accessible computer device. Verification of a user's authorization to access a user account may include a request transmitted by the account module 105. The request may ask the user to produce one or more types of authentication credentials demonstrating a user's rights to access the requested user account stored by the account module 105 or another component of system 100. Once authorized, the user may purchase items from a store and remotely bill the authorized account linked to the system 100 for the products selected and purchased using the system 100.

Examples of account authorization may include password authentication, smart card authentication or a biometric authentication. For instance, the account module 105 may receive biometric data for the purposes of authentication and identification of the user through one or more authenticating devices. Authenticating devices may use visual or audio devices such as a camera, biometric camera and/or microphone for the purposes of facial recognition, iris scanning, fingerprint scanning, voice recognition, hand recognition, signature recognition or other forms of biometric input known by individuals skilled in the art. In some embodiments, the video input device 125, described below may be an authenticating device. For example, the video input device 125 may be a video camera, security camera or biometric device connected to the system 100. Upon entering a store, the video input device 125 may utilize biometric scanning to identify the user, link the computer system 101 to system 100 and authorize the system 100 to load the user's account information as a function of the user's identification by the video input device 125. Authenticating devices such as the video input device 125 may be integrated into the computer system 101, in some embodiments, o the video input may be a separate stand-alone device connected to the computer system 101 or network 120, for example through a USB, PCI, PCIE, Fire wire or other port.

In some embodiments of the point of sale system 100, the shopping module 103 may include a location module 107. The location module 107 may include hardware and/or software for identifying the current geographic position or track a series of previous geographic positions of the computer system 101. The location module 107 may be particularly useful when the computer system 101 is a device that is less stationary, such as a mobile communication device, smartphone, tablet or laptop computer. Embodiments of the system 100 may track the location of the computer system 101, the computer system's proximity to a particular store, and upon entering within a specified distance of a store, the computer system 101 may connect to the network 120 of the system 100 and begin searching for one or more RFID devices 123 linked to products sold by the store.

In some embodiments, the location module 107 may include hardware and software capable of accessing the global positioning system (GPS). For example, a GPS antenna, transmitter, transponder, transceiver or receiver may be connected to the computer system 101, integrated into the hardware of location module 107 or virtualized GPS hardware. The location module 107 may acquire the GPS location of the computer system 101 from GPS satellites and may store location data of the computer system 101 in the memory device 116, the account module 105, remotely in the product management system 127 or the network accessible data store 129. In alternative embodiments, the location module 107 may identify the position of the computer system 101 using cell tower triangulation, Bluetooth beacons, Wi-Fi or other radio-based systems for determining positioning known by a person skilled in the art.

The location module 107 may continuously and/or periodically obtain, save and track the geographical position of the computer system 101. The location module 107 may periodically compare the current location of the computer system 101 with one or more mapping programs stored by the memory device 116 or other computer readable storage device. The location module may utilize the mapping programs to identify whether or not the computer system 101 has entered a specific location. For example, the system 100 may use the location data collected by the location module 107 to identify the proximity of the computer system 101 to one or more different stores where a user may enter the store and purchase items sold inside the store using the automated point of sale system 100. As the user comes into proximity with a particular store location that is equipped with system 100, the computer system 101 may connect to the system's 100 network 120, authenticate the user's account via the account module and begin tracking the position of the computer system 101 in relation to the products available for sale. Upon connecting to the network 120, the computer system 101 may search for nearby products containing an RFID device 123 or other broadcasting technologies, as described below.

In some embodiments, the location module 107 may establish one or more geofences around a particular location or store. When the location module's 107 location data indicates that a user has crossed a geofence barrier, the computer system 101 may connect to network 120 of system 100, identify the user's account to the product management system 127 and begin searching for nearby RFID devices 123. The network 120 may be a group of computer systems or other computing devices linked together through communication channels to facilitate communication and resource sharing among the computer systems and hardware devices of connected to the network. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art. Embodiments of the computer system 101 may connect to the network 120 via a network adapter or network interface controller 119. The network interface controller 119, as shown in FIG. 1 may allow for data to be transferred and received between the computer system 101 and each of the devices connected to the network 120.

In some embodiments, network interface controller of computer system 101 may be a wireless interface, which may include a wireless transmitter, receiver or transceiver. The wireless signals and data being transmitted between each of the devices connected to network 120 may be transmitted wirelessly between the sensors 121 or other devices of network 120 and the computer system 101. For example, the wireless network may be established using Wi-Fi, Bluetooth, Bluetooth low energy (BLE), ZigBee, WiMAX, light fidelity (Li-Fi), infrared or other wireless communication protocols known by those skilled in the art.

Embodiments of the shopping module 103 may further comprise an RFID module 108. Embodiments of the RF module 108 may include an RFID reader and/or RFID antenna. The RFID module 108 may utilize the RFID read and/or antenna to facilitate communication between the computer system 101 and one or more RFID devices 123a to 123n (hereinafter “RFID device 123”) positioned throughout the store or location near the computer system 101, including one or more RFID tags affixed to the products available for purchase. It should be noted that elements depicted in the figures having reference numbers starting with a sub-letter “a” after the reference number followed by ellipses and a n^{th} sub letter, for example the RFID devices 123a . . . 123n, may signify that the embodiments of the element references are not limited only to the amount of elements specifically shown in the drawings. Rather, the ellipses between the first element having the “a” and the n^{th} element indicated to be the last in a series or set of similar elements. For instance, referring to RFID device 123, any number of a plurality of RFID devices may be present, including RFID 123a, 123b (not shown), RFID 123c (not shown) and numerous additional RFID devices up to and including the n^{th} number of RFID devices 121n. Wherein the variable “n” may represent the last element in a sequence of similar elements shown in the drawing.

Embodiments of the RFID module 108 may perform the function or task of activating or exchanging an emitted signal with nearby RFID devices 123. Each RFID device 123 may be connected to a specified product available for purchase. For example, the RFID devices 123 may be attached to each product as a product tag or integrated into the packaging of the product. The RFID device 123 may store product information relevant to the product attached to the RFID device 123. Product information may include the product name, price, location, weight, manufacturer, origin and other identifying characteristics. In some embodiments, the RFID module 108 may transmit commands or instructions to computer system 101 requesting the computer system to emit a signal to search for nearby RFID devices 123. In alternative embodiments, the RFID module 108 may activate as a function of the computer system's proximate location to a store. Embodiments of the RFID module 108 may limit the strength of the emitted signal, frequency or directionality of the signal in order to control the distance and number of RFID devices 123 identified near the computer system 101. In the exemplary embodiment, the RFID module 108 may limit the signal strength of the emitted signal broadcasted to nearby RFID devices 123 in order to limit the RFID devices 123 interacting with the RFID module 108 at the time of broadcasting the signal to only the RFID devices 123 in the immediate proximity of the computer system 101.

In some embodiments of system 100, the RFID module 108 may actively emit the signal that pings the nearby RFID devices 123 and establishes a connection between the computer system 101 and the RFID device 123. In alternative embodiments, the RFID module 108 may be manually commanded by computer system 101 to emit a signal to nearby RFID devices 123, so that the user may exhibit greater control over the RFID devices 123 being connected to by the computer system 101. In yet another embodiment, the RFID device 123 may passively listen for signals being emitted by actively broadcasting RFID device 123. Once the computer system 101 comes in close proximity to an actively broadcasting RFID device 123, the RFID module 108 may receive and store the product information.

Embodiments of the RFID module 108 may include specialized hardware and/or software for communicating with RFID devices 123, including hardware for reading RFID tags. In some embodiments, the RFID module 108 may include a passive reader for reading signals from actively emitting RFID devices 123. In alternative embodiments, the RFID module 108 may be an active reader which may be capable of reading passive RFID devices 123 or active RFID devices 123. In passive systems, the RFID device 123 may be inactive or lack power until the RFID module 108 is close enough to energize the RFID device 123 with the radio waves produced during signal emission.

In the Exemplary embodiment of the automated point of sale system 100, a user may enter the store and computer system 101. The computer system 101, equipped with an RFID module 108 or RFID module 108 remotely accessible via network 120, may broadcast a signal to search for passive RFID devices 123 or search for signals broadcasted by active RFID devices 123. As the computer system 101 is placed into close proximity with a product's RFID device 123 (for example, when the product is removed from the shelf or placed into the user's cart), the RFID module 108 may retrieve product information stored by the RFID device 123. The exchange of product information may indicate the user has selected the product with intention to purchase the product. The product information received by the RFID module 108 from the RFID device 123 may be stored by the RFID module 108, the memory device 116 of the computer system, the product management system 127 or a network accessible data store 129. In alternative embodiments of system 100, the user may manually scan for nearby RFID devices 123 and select from an interface loaded onto the computer system 101, one or more nearby products the user intends to purchase from the store.

Embodiments of the RFID device 123 may include RFID systems operating in a low frequency band (30 kHz to 300 kHz), which may have a short reading range of 10 cm; a high frequency (HF) RFID operating in the HF band of 3 to 30 MHz; or ultra-high frequency RFID which may operate in the 300 MHz to 3 GHz radio band. In some instances, a RFID device 123 operating using a HF band for transmission or reception may be referred to as a near field communication (NFC) device. A NFC device may be considered a subset of the RFID device 123. Embodiments of the RFID device 123 may be an active RFID system, a passive RFID system, or a battery-assisted RFID system. Examples of RFID devices 123 that may store product information may include electronic product code (EPC) tags, paper tags, inlay tags, glue tag, key tag, glass tube tag, ceramic tag, disc tag or pocket tag. Upon establishing communication between the RFID module 108 and the nearby RFID devices 123, the RFID module 108 may request transmission of the product data stored in the memory or chipset of the RFID device 123.

Embodiments of system 100 may further utilize sensor technology to automate the point of sale system and as an extra measure for verifying the products selected. The system may include a plurality of sensors 121 placed in various sections of the store to monitor the placement or organization of products displayed for sale. For example, the sensors 121 may monitor products displayed on a shelf, pallet or aisle display. The sensors 121 may emit an initial signal indicating a current state or condition, such as the presence of a particular product. Upon disturbance or removal of the product, the sensor's 121 signal output may change as a function of the product removal or change in position. Changes in signal output in conjunction with the receipt of product information from an RFID device 123 may indicate to system 100 that the product has been selected by the user for purchase.

In one or more embodiments of the system 100 utilizing sensors 121, the shopping module 103 may include a sensor module 109. The sensor module 109 may transmit, receive and/or store communications and sensor data transmitted one or more sensors 121a to 121n (hereinafter “sensors 121”). The sensor module 109 may receive the sensor data from each nearby sensor 121, interpret or calculate the changes in the sensor's output signal as a function of the sensor data and/or determine whether or not a customer has removed product from the product's original location within the store. In alternative embodiments of the system 100, the sensors 121 may communicate via the network 120 with a sensor module 109 of a product management system 127. Instead of the computer system 101 monitoring and identifying the removal of product, the product management system 127 may do so. In the event of a change in sensor data indicating a change in product placement within the store, the product management system 127 may confirm that the product has been removed via a networked video input device 125 or by transmitting a request to the computer system 101 to confirm that the computer system 101 has received product information from one or more RFID devices 123 within the proximity of the sensor 121.

Embodiments of the sensors 121 may act as a mechanism for verifying removal of product from the product's original location in the store. The system 100 may use the sensors 121 and sensor data to assist the system 100 in identifying or confirming the selection of one or more products being purchased by a customer. As customer approaches and selects items for purchase, the user may initiate communication between the RFID module 108 and RFID device 123 attached to the product selected. The shelf, storage area or display area of the store holding the product, may be monitored by one or more sensors 121. Embodiments of sensors may include, but are not limited to acoustic sensors, sound sensors, optical sensors, chemical sensors, electric sensors, magnetic sensors, mechanical sensors or proximity sensors. For example, in some embodiments, the sensors 121 may include mechanical sensors such as a force sensitive resistor, pressure plate sensor, weight sensor, pressure or other tactile sensor to monitor a shelf containing one or more products. Once the position of the product is disturbed or removed from the shelving or display area, the removal of the product from the original position may modify the area being monitored by the sensor 121 (e.g. a decrease in the amount of force or weight on the shelf) and thus indicate a change in the sensor's output. The sensor device comprising the sensor 121 or a product management system 127, may track the types of products and product information associated with or assigned to each of the sensors 121. The types of product information known may include a product's size or weight. As the product is removed from the zone monitored by the sensor 121, the amount of weight removed from the shelf may indicate the quantity of products selected by the customer, or in the case of a shelf having a mixture of products, the amount of weight removed from the shelf may indicate that one or more products have been removed.

In some embodiments of system 100, the system 100 may comprise one or more video input devices 125. The video input device 125, similar to the sensors 121, may act as a secondary component of the system 100 for verifying product selection by the customer in some embodiments. In other embodiments, the video input device 125 may be used for verifying a customer's identity as described above. Embodiments of the system 100 may include a plurality of video input devices 125 mounted throughout the interior and/or exterior of the store. Each of the video input devices 125 may record customers as each customer interacts with various products placed throughout the store. The video input device may transmit the video data recorded by the video input device 125 to a central storage location of the system such as data store 129 and/or product management system 127 or computer system 101.

Embodiments of the video input device 125 may include camera systems capable of identifying the customers and various products or objects for sale throughout the store. The video input device 125 may include biometric software or object recognition software, which may be directly, loaded into the memory of the video input device, product management system 127 or memory device 116 of the computer system 101. Embodiments of the video input device 125 loaded with object recognition software may be referred to as an object recognition camera.

The recording module 111 may allow for the computer system 101 or other components of system 100 to transmit and receive data from video input device 125. In some embodiments, the recording module and retrieve and store visual verification data recorded by the visual input device 125. Visual verification data may include video evidence confirming the selection of a product by a customer. The visual verification data collected by the video input device 125, in combination with the product information retrieved from RFID device 123 and sensor data from sensor 121 may, in combination lead to analysis and conclusion by the system 100 that a customer has selected and removed one or more products from the store with an intent to purchase the products.

Embodiments of the video input device 125 may not only confirm the type of products selected for purchase, but may also confirm the quantity of products selected. For example, a video input device 125 configured with object recognition software, may be able to identify various product shapes, logos, packaging, bar codes etc. and distinguish multiple products from one another as the products are selected by the customer. The visual verification data collected by the video input device 125 may be cross referenced with the RFID device's 123 stored product information and the nearby sensor 121 to confirm the accuracy of the video input device's product recognition and analysis. For example, the product management system 127 may receive sensor data, visual verification data and product information stored by an RFID device 123, wherein each of the information received is tied to a particular customer account, linked to system 100. The product management system 127, may as a function of the sensor data, visual verification data and product information draw one or more conclusions regarding the product selections made by the customer while the customer is present in the store. In some embodiments, the video input device 125 may be used in combination with the location module 107 of the computer system 101 to verify incoming and outgoing customers from the store. The video input device 125 may trigger the completion of the product purchase as a function of a customer leaving the store. For example, as the customer leaves the store, the video input device may confirm the user's identity and transmit a request for the product management system 127 to complete the transaction for all items placed in the customer's virtual shopping cart.

In some embodiments of the system 100, the video input device 125 may transmit an alert or notification to a store employee for the purpose of requesting assistance for a customer. As the customer shops in the store, the video input device 125 may track the customer's movements and product selections. Embodiments of the video input device may recognize large or heavy products which may require assistance to load in the customer's vehicle. Similarly, the video input device may also identify small, frail or elderly customers which may not be able to carry or load products in the customer's vehicle themselves. The system 100 may recognize the circumstances where a customer may appreciate assistance and transmit an alert requesting assistance along with location information of where to find the customer within the interior or exterior of the store.

Embodiments of the shopping module 103 may comprise in some embodiments a shopping cart module 112. The shopping cart module 112 may organize and store virtual representations of products selected for purchase by the customer prior to processing payment to finalize the transaction. In some embodiments, the shopping cart module 112 may receive product information from the RFID module 108, sensor data from the sensor module 109 and/or visual verification data from the recording module 111 (collectively referred to as “product verification data”). The shopping cart module 112 may analyze the product verification data to verify that each component of the product verification data confirms that the correct products have actually been selected by the customer, the quantity of the products and the price of the products. The shopping cart module 112 may input the product verification data into an analytics program or other statistical analysis tool and draw one or more conclusions about the contents of the customer's physical shopping cart, basket or other device for maintaining the physical products, as well the intent to purchase the products by the customer as a function of the analyzed product verification data. As a function of the shopping cart module's 112 conclusions of the customer's product selection and intent to purchase, the shopping cart module 112 may generate a list of products selected, the quantity of each product, and the price of the products. The shopping cart module 112 may calculate a total cost for the contents of the virtual shopping cart and upon receiving a request for processing the sales transaction; the shopping cart module may transfer the calculated total and list of products to the payment module 113 for completion of the transaction.

Embodiments of the payment module 113 may negotiate payment of the products loaded in the shopping cart module 112 and finalize the payment transaction. The payment module 113 may store or retrieve payment information linked to the user account of the account module 105. Embodiments of the payment module 113 may receive a request for processing the sales transaction from the system 100. Embodiments of the payment module may receive the calculated total tabulated by the shopping cart module 112 and transmit the request for processing payment along with the calculated total, and product descriptions over the network to the product management system 127. The product management system 127 may confirm the transaction request, the user's account's payment information, the total cost of the products selected. Once confirmed, the product management system 127 may complete the payment transaction by billing the total cost for the products selected by the customer to the payment information provided by the user's account.

In some embodiments, the product management system 127 may, at the conclusion of the transaction negotiation with the payment module 113, confirm receipt of payment. Upon confirmation of the receipt of payment by the product management system 127, the payment module 113 may create an electronic receipt. The electronic receipt may include payment confirmation, the description of the products purchased, the quantity purchased and the time that the transaction occurred. In some embodiments, the electronic receipt may include product verification data, including video data from the video input device 125. The data of the electronic receipt, including product verification data may be transmitted to the reporting module 115, which may display the electronic receipt on a display device 130 that may be connected to the computer system 101, for example through an I/O interface 117 or remotely accessible via network 120. In some embodiments, the reporting module 115 may further provide access to the visual verification data and allow for the customer to display the visual verification, providing visual proof that the products charged to the user's account were properly identified.

### Method for Automating a Point of Sale System

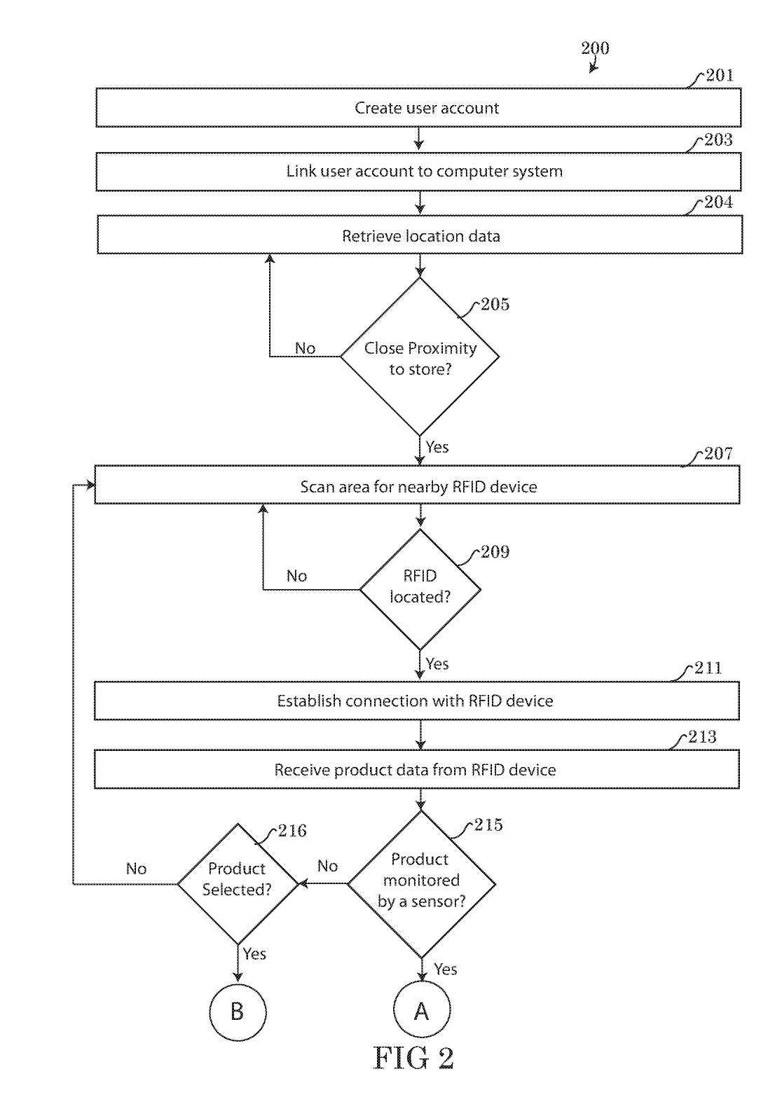

The drawing of FIG. 2-4 represent embodiments of a method or algorithm that may be implemented for automating a point of sale system in accordance with the system diagram described in FIG. 1, using one or more computers defined generically in FIG. 5 below, and more specifically by the specific embodiments depicted in FIG. 1. A person skilled in the art should recognize that the steps of the algorithm described in FIGS. 2-4 may not require all of the steps disclosed herein to be performed, nor does the algorithm of FIGS. 2-4 necessarily require that all the steps be performed in the particular order presented. Variations of the method steps presented in FIGS. 2-4 may be performed wherein one or more steps may be performed in a different order than presented by FIGS. 2-4.

The method for automating a point of sale system 100 as described by embodiment 200, may initiate in step 201. In step 201, the customer or user of the point of sale system 100 may create a user account. The user account may be personalized to the user registering the account. The user account may contain personal information stored by the system 100 about the user/customer, including the customer's location, preferred store locations, descriptive information about the customer's appearance, purchasing history and habits as well as payment information such as credit card numbers and bank accounts linked to the user account. The user account created in step 201 may be linked to the point of sale system in step 203, allowing for the system 100 or components of the system 100 such as the computer system 101 and product management system 127 to access the user account information and transact the purchases using the payment information linked to the account.

In step 204 of embodiment 200, the system 100 may retrieve location data of a computer system 101 linked to the account created in step 201. The location data may be collected and stored periodically or continuously by the location module 107. The location data may track the location of the computer system 101 and therefore the location of the customer in relation to a store. In some embodiments, the location module 107 may transmit location data over network 120 to the product management system or other networked computer devices of network 120. In step 205, the system 100 may compare the current location of the customer's computer system 101 as indicated by the location data collected by the location module 107 with location information of known stores equipped with system 100. In some embodiments, the location module 107 may download location information of one or more merchants or stores from a database or other data set stored by the network 120. For example, location information may be downloaded and stored by the location module 107 from the data store 129. If, in step 205, the location data collected by the location module 107 indicates the computer system 101 is not within a particular proximity to a merchant or store equipped with the automated point of sale system 100, the location module 107 may continue to collect and compare location data as described in step 204.

If, in step 205 it is determined that the location data collected by the location module 107 indicates that the computer system 101 is within the pre-determined proximity to merchant store location equipped with the automated point of sale system 100, the computer system 101 may enable or activate the RFID module 108 to begin scanning or searching for RFID devices 123. In step 207, the RFID module 108 of the computer system 101 may scan the nearby area for one or more RFID devices 123. The scanning step of step 207 may be performed automatically as a function of the proximity of the computer system 101 to the store in some embodiments. In alternative embodiments, a user of the computer system may manually select the scanning feature of the RFID module 108. In some embodiments, the user may initiate the scanning step by touching the computer system 101 to product or RFID device 123. The RFID Module may emit a radio wave or other signal readable by nearby RFID devices 123, within a programmed proximity to the RFID module 108. In the exemplary embodiment, to ensure the accuracy of product selection by the customer, the RFID module 108 may limit the distance of the searching signal is emitted to limit the number of responding RFID devices 123 identified. Therefore in the exemplary embodiments, the responding RFID device 123 responding to the emitted signal may be within a short distance, making contact with the RFID module 108 or nearly making contact with the RFID module 108.

As a result of the scan performed by the RFID module 123 in step 207, a determination may be made by the RFID module 108 whether or not a RFID device 123 was successfully located. If, in step 209 it is determined by the RFID module 108 that there is not an RFID device 123 within the detectable vicinity of the RFID module 108, the RFID module 108 may continue to continuously or periodically emit a signal to scan for an RFID device 123. The scanning may occur until the user instructs the RFID module 108 the scanning function or the computer system 101 is no longer within the appropriate proximity of the store.

If, on the other hand, the RFID module 108 identifies a location of a RFID device 123 in step 209, the RFID module 108 may establish a connection with the RFID device 123 in step 211. The connection may be facilitated in one or more different manners depending on the type of RFID device 123 being used and the RFID reader incorporated into the RFID module 108. In an embodiment wherein the RFID device 123 is a passive RFID device, the RFID module 108 may be an active RFID reader, emitting a radio signal emitting a radio signal that may come into contact with the passive RFID device 123, energizing the passive RFID device. In alternative embodiments, the RFID module 108 may include a passive RFID reader connecting with an active RFID device 123. Instead of the RFID module emitting a signal, the active RFID device 123 may emit the radio signal instead. When the RFID module 108 comprising an RFID reader or antenna comes within the detection range of the RFID device 123, a connection between the RFID module 108 and RFID device may be established.

Once the RFID device 123 has been placed into communication with the RFID module 108 of the computer system 101 in step 211, the method may proceed to step 213. In step 213, the RFID module 108 may receive or extract product data containing product information stored by the RFID device 123. The product data received in step 213 may include a description of the product associated with the RFID device 123 as well as the product's price, origin, manufacturer, serial number, unique inventory identifier, merchant store's location, etc. Each individual product may include a unique identifier stored by the RFID device which may be tracked by the product management system 127 for the purposes of maintaining the current inventory of the store and for further differentiating each different product from one another. Moreover, the unique identifier of the product may assist the point of sale system 100 in identifying when multiple quantities of the same type of product are selected by a customer for purchase by having a unique identifier for each product retrieved from multiple RFID devices 123.

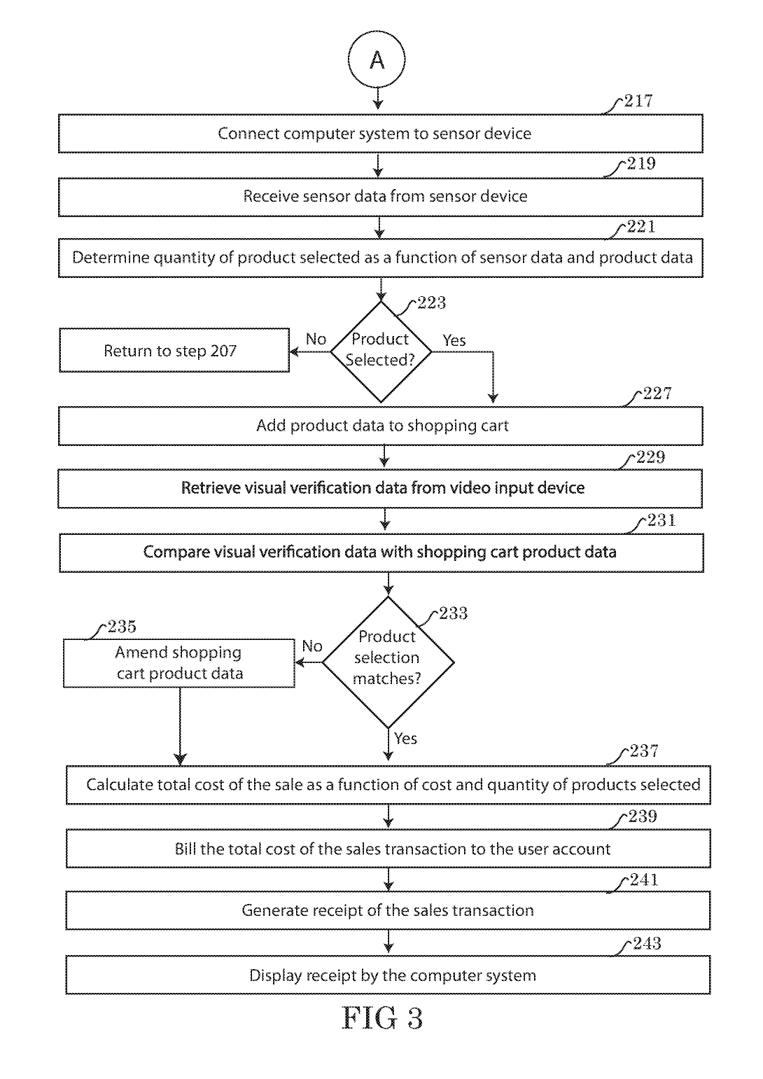

After receiving the product data from the RFID device 123 connected to the computer system 101 in step 215, embodiments of method 200 may identify whether the system 100 further includes one or more sensors 121 monitoring the product associated with the RFID device 123. If in step 215, the system 100 includes a sensor 121 monitoring the product associated with RFID device 123, the embodiment of the method may be continued via pathway “A” continuing on FIG. 3 of the drawings.

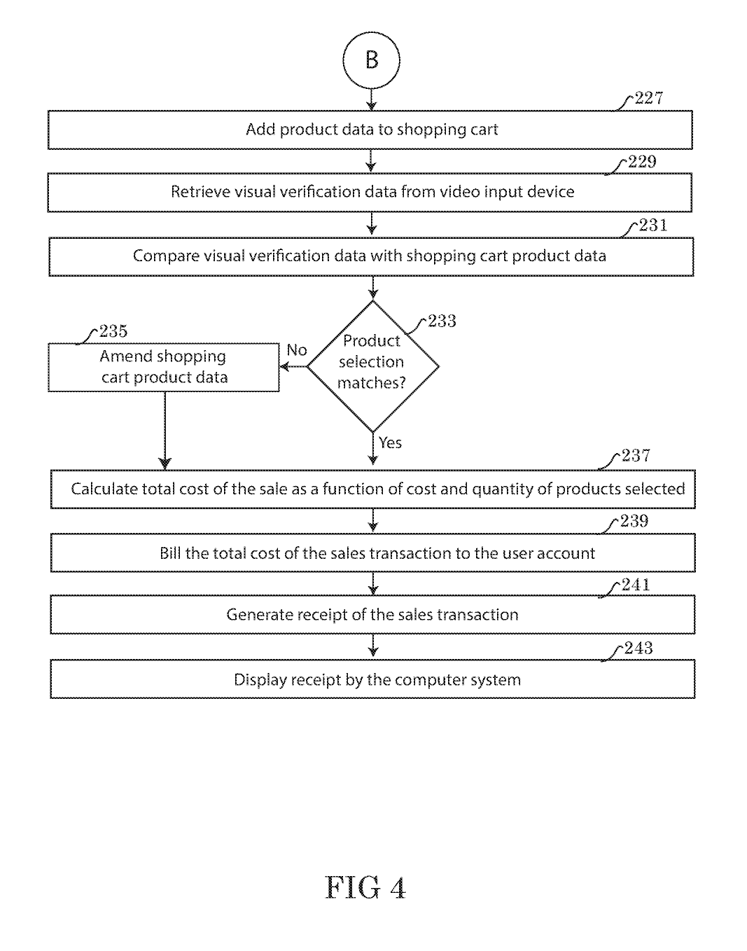

Otherwise, if the system 100 does not include sensors 121 or the product associated with the RFID device is not monitored by a sensor 121, embodiments of the method may move on to step 216. In step 216 the system 100 may determine whether or not a product has been selected by the customer for purchase, based on the proximity to the RFID device 123 to the computer system in some embodiments and the exchange of product data in steps 211 and 213. In alternative embodiments, the RFID module 108 may periodically scan to determine if the RFID module 108 has maintained close proximity to the RFID device 123 despite a change in location data collected by the location module. A change in location coupled with maintaining a close proximity to the RFID device 123 may indicate that the user has removed the product containing the RFID device 123 from the original location in the store and has collected the product in a nearby shopping cart, basket or holding the product as the customer moves through the store. If it is determined by the system 100 that the product has not been selected in step 216 by the customer, the method may proceed back to step 207 and continue scanning for other nearby RFID devices 123. On the other hand, if the product has been selected in step 216, the embodiments of the method 200 may proceed to pathway “B” continuing on FIG. 4 of the current application.

Referring to the drawings, FIG. 3 describes a method that may be a continuation of the method described in FIG. 2. Embodiments of the method may continue along pathway “A” following the determination made in step 215 that the product attached to the RFID device 123, communicating with the RFID module 108, may be associated with one or more sensors 121 monitoring the storage or display area of the product. In step 217 of the method, the sensor module 109 of the computer system 101 may connect to a sensor device comprising sensor 121 in some embodiments, for example via the computer network 120. The sensor module 109 may request sensor data from the sensor device and in step 219 of the method, the sensor data may be received by the sensor module 109 from the sensor device equipped with the sensor 121.

Alternatively, in some embodiments, the product management system 127 may be connected to the sensor device and receiving the sensor data from the sensors 121 in steps 217. In some embodiments, the sensor module 109 may connect to the product management system 127, request the sensor data and receive the sensor data from the product management system 127 in step 219. The product management system 127 may transmit the sensor data over network 120.

The sensor data received in step 219 may assist the system 100 in identifying whether or not one or more products have been selected by the customer from the store shelves or display and further determine the quantity of items selected by the customer. The amount of change to the sensor's 121 initial signal being emitted and the resulting signal output after the customer interacts with the products may be indicative of product removal with intent to make a purchase. Likewise, if a sensor 121 does not detect a change in the sensor signal after the user has come into close proximity with an RFID device 123, the lack of change to the sensor monitoring the product may mean that the transmission of the RFID product data to the computer system 101 may be a false indication of a potential purchase.

For example, a customer may arrive at a store and approach a product maintained on the store shelves that are being monitored by a sensor 121. In particular, the shelf may be a pressure plate or other type of sensor 121 monitoring the weight of products on the shelf. The sensor 121 may detect changes in the weight of the shelf as a function of products being removed therefrom. In one instance, the computer system 101 may connect to an RFID device 123 and receive product data, indicating a high probability that the customer has come in close enough contact with the product to initiate communication between the RFID device and the RFID reader of the RFID module 108. Subsequently, the sensor 121 calculates changes in the sensor data describing the weight of the products on the shelf containing the selected product, was indeed reduced by the amount of weight attributed to the product associated with the RFID device 123. Thus, there is a very high likelihood that the product was selected by the customer. Conversely, if the sensor data does not indicate a change consistent with the removal of the product associated with the RFID device 123, there is a much lower probability that the product has been selected for purchase by the customer. The system 100 may determine that the product was not selected by the customer or the computer system may initiate visual verification described in step 229 below to make a determination whether the product has been selected.

In step 221, the system 100 may determine the quantity of the product selected for purchase as a function of the received product data transmitted from nearby RFID devices 123 and sensor data received from sensors 121 monitoring the associated product. If there are multiple unique products identified corresponding to multiple RFID devices 123 as well as corresponding sensor data suggesting multiple products have been retained by the customer, the appropriate quantity of products may be identified by the system. If the quantity of products determined in step 221 is zero, then, in step 223, the system 100 may determine that a product has not been selected and thus return to step 207 and continue scanning for additional RFID devices 123 nearby. Conversely, if the quantity of product selected in step 221 is one or more, then in step 223 the system 100 may identify that a product has been selected. The computer system 101 may proceed to add the product data received from the RFID device 123 in step 213 to a virtual shopping cart in step 227, maintained by the shopping cart module 112.

Embodiments of the method for automating the point of sale system may further utilize the visual input devices 125 to confirm that the product was actually selected by the user and thus properly added to the shopping cart in step 227 in the appropriate amounts determined in step 221. In step 229, the recording module 111 may retrieve visual verification data recorded by the video input device 125. The visual verification date may include a video recording of the customer selecting the products from the store shelves, storage area or displays and the data may further include object recognition of each item identified as well as the quantity thereof. The recording module 111 may store a list of products identified by the visual verification data and in step 231 compare the products identified by the visual verification data with the products currently stored in the shopping cart module 112.

In step 233, a determination may be made by the system 100 whether the comparison between the products identified by the visual verification data matches the product data describing the products currently retained by shopping cart in step 227. If the determination by the shopping module 103 concludes that the product selection and quantity of products for both the visual verification data and the shopping cart matches, the shopping module 103 may proceed to step 237 and calculate the total cost of the products placed in the shopping cart. However, if the product selection does not match in step 233, in step 235 the shopping cart module 112 may amend the product data stored by the shopping cart. The amendment to the product data stored by the shopping cart may consolidate the product data to include products that have been visually verified by the visual verification data of the visual input device. The remaining products that may be present in the shopping cart, but determined in step 235 not to be selected by the customer according to the visual verification data may be removed from the shopping cart.

In step 237 of the embodiment of the method for automating a point of sale system, the shopping cart module may proceed to calculate the total cost of the products remaining in the shopping cart after the visual verification step 231. The total cost of the product may be calculated as a function of the cost according to the product data and the quantity of the products selected by the customer. The cost calculation may be forwarded to the payment module 113 for negotiation and completion of the purchasing transaction.

In step 239 of the embodiment of the method for automating a point of sale system 100, the payment module 113 may negotiate billing the total cost of the transaction to the user account linked to the system in step 203. The payment method used for paying the total cost of the purchase may be the payment information stored by the user account. In some embodiments, the method of billing the user account may include the step of transmitting from the computer system 101, a payment transaction request to the product management system 127. The payment transaction request may include shopping cart data such as the products selected for purchase, the quantity, total cost and payment information which may be encrypted for security purposed before transmitting the payment transaction request. The Product management system 127, upon receiving the payment transaction request, may verify the shopping cart data and the payment information. The product management system may accept or deny the payment transaction request. Upon accepting the payment transaction request, the product management system 127 may facilitate the settlement of the payment transaction and request the transition of funds from the user's account to a merchant account maintained by the store's product management system 127.

Accordingly, after the completion of the funds transfer between the user account and the merchant's account, the product management system 127 may, in step 241 generate an electronic receipt of the sales transaction previously performed in step 239. The electronic receipt may include information relating to the transaction including the products purchased, the price per product, the quantity of products, payment information (either redacted or not) and the date and/or time the transaction was completed by the product management system. The generated sales receipt may be transmitted to the computer system 101. In some embodiments, the electronic receipt may be recorded to the user's account and stored by the account module 105. In other embodiments, the payment module 113 may record the payment transaction and transmit the information to the reporting module 115. In some embodiments, the product management system 127 may store a copy of the electronic receipt to a network accessible storage device, such as data store 129, wherein the customer may remotely access the sales receipt through network 120 and download a copy of the sales receipt if desired. Subsequently, the reporting module 115 may, in step 243, display the sales receipt on a display device 130 connected to the computer system 101 wherein each of the details describing the transaction in the electronic receipt are viewable.

Referring to the drawings, FIG. 4 may describe an alternative embodiment of the continuation of the method 200 described in FIG. 2. The method described by FIG. 4 may continue the method for automating a point of sale system by following the pathway “B” instead of pathway “A” described in FIG. 3. The embodiment of the method 200 continuing along pathway “B” may be a method for automating a point of sale system 100 that may not utilize sensors 121 as part of the system 100. Instead, the system may utilize RFID technology, location data and visual verification by a visual input device 125 to confirm product selection and quantity.

The embodiment method 200 described by pathway “B” may continue from step 216 after determining that a product has been selected as a function of receiving product data from the RFID device 123 as the RFID device 123 comes into close enough proximity with the RFID module 108 to connect and transmit the product data. Instead of connecting to the sensor and receiving sensor data to further validate the selection of products by the customer as described above in steps 217, 219 and 221 above, the continuation of method 200 along pathway B may add the product data to the shopping cart as described in step 227 below as a function of receiving the product data from the RFID device in step 213. Subsequently, after adding the product data to the shopping cart maintained by the shopping cart module 112, pathway B may perform steps 229, 231, 233, 235, 237 239, 241 and 243 as previously described above.

### Computer System

Referring to the drawings, FIG. 5 illustrates a block diagram of a generic computer system 500 that may be included in each of the systems of FIGS. 1, for implementing methods for automating a point of sale system as shown in the embodiment of FIGS. 2- 4 and in accordance with the embodiments of the present disclosure. The computer system 500 may generally comprise a CPU, otherwise referred to as a central processing unit (CPU) 591, an input device 592 coupled to the CPU 591, an output device 593 coupled to the CPU 591, and memory devices 594 and 595 each coupled to the CPU 591. The input device 592, output device 593 and memory devices 594, 595 may each be coupled to the CPU 591 via a bus. CPU 591 may perform computations and control the functions of computer 500, including executing instructions included in the computer code 597 for tools and programs for automating a point of sale system, such as the shopping module 103 and the sub-modules described herein, in the manner prescribed by the embodiments of the disclosure using the systems of FIG. 1. The instructions of the computer code 597 may be executed by CPU 591 via memory device 595. The computer code 597 may include software or program instructions that may implement one or more algorithms for automating a point of sale system, as described in detail above. The CPU 591 executes the computer code 597. CPU 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail in this application. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to CPU 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in the figures.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, sensors, biometric input device, camera, etc. The output device 593 may be, inter alia, a printer, a plotter, a display device (such as a computer screen or monitor), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in the computer system 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to reordering a consumable product. Thus, an embodiment of the present disclosure discloses a process for supporting computer infrastructure, where the process includes providing at least one support service for at least one of integrating, hosting, maintaining and deploying computer-readable code (e.g., program code 597) in a computer system (e.g., computer 500) including one or more CPU(s) 591, wherein the CPU(s) carry out instructions contained in the computer code 597 causing the computer system to reorder a consumable product. Another embodiment discloses a process for supporting computer infrastructure, where the process includes integrating computer-readable program code into a computer system including a CPU.

The step of integrating includes storing the program code in a computer-readable storage device of the computer system through use of the CPU. The program code, upon being executed by the CPU, implements a method of automating a sale of a product. Thus the present invention discloses a process for supporting, deploying and/or integrating computer infrastructure, integrating, hosting, maintaining, and deploying computer-readable code into the computer system 500, wherein the code in combination with the computer system 500 is capable of performing a method for automating a sale of a product.

A computer program product of the present invention comprises one or more computer readable hardware storage devices having computer readable program code stored therein, said program code containing instructions executable by one or more CPUs of a computer system to implement the methods of the present invention.

A computer program product of the present invention comprises one or more computer readable hardware storage devices having computer readable program code stored therein, said program code containing instructions executable by one or more CPUs of a computer system to implement the methods of the present invention.

A computer system of the present invention comprises one or more CPUs, one or more memories, and one or more computer readable hardware storage devices, said one or more hardware storage devices containing program code executable by the one or more CPUs via the one or more memories to implement the methods of the present invention.

The present invention may be a system, a method, and/or a computer program product at any possible technical detail level of integration. The computer program product may include a computer readable storage medium (or media) having computer readable program instructions thereon for causing a CPU to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a CPU of a general purpose computer, special purpose computer, or other programmable data processing apparatus to produce a machine, such that the instructions, which execute via the CPU of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for automating a point of sale system comprising the steps of:
establishing, by a central processing unit (CPU) of a computer system, a connection between the computer system and a radio-frequency identification (RFID) device associated with a product;
receiving, by the CPU, product data transmitted by RFID device;
further receiving, by the CPU, visual verification data identifying a quantity of the product selected for sale, the visual verification data being transmitted to the CPU by an object recognition camera;
calculating, by the CPU, a total cost of the sale as a function of the product data and the quantity identified by the visual verification data; and
billing, by the CPU, the total cost of the sale automatically to an account accessible by the computer system.

2. The method of claim 1, further comprising the step of:
compiling, by the CPU, an electronic receipt reciting each product billed to the account accessible by the computer system; and
displaying, by the CPU, the electronic receipt.

3. The method of claim 1, further comprising the steps of:
connecting, by the CPU, the computer system to a sensor device; and
retrieving, by the CPU, sensor data from the sensor device; and
determining, by the CPU, the quantity of the product selected for the sale as a function of the sensor data and product data.

4. The method of claim 3, further comprising the step of:
comparing, by the CPU, the quantity of the product selected as a function of the sensor data to the quantity of the product selected as a function of the visual verification data; and
verifying, by the CPU, that the quantity of the of the product selected as a function of the sensor data is equal to the quantity of the product selected as a function of the visual verification data.

5. The method of claim 1, further comprising the step of:
transmitting, by the CPU, a request for assistance upon receiving the product data transmitted by RFID device to the CPU.

6. The method of claim 5 further comprising the step of:
storing, by the CPU, visual verification data as video data confirming completion of the sale; and
displaying, by the CPU, the video data.

7. The method of claim 1, wherein the RFID device is a near field communication (NFC) device connecting to the computer system as a function of the distance between the NFC device and computer system.

8. An automated point of sale system, comprising:
a computer system comprising a central processing unit (CPU), a memory device coupled to the CPU and a computer readable storage device coupled to the CPU;
an object recognition camera system electronically communicating with the CPU;
a radio-frequency identification (RFID) device electronically communicating with the CPU; and
the computer readable storage comprises program code executable by the CPU via the memory device to implement a method for automating the point of sale system comprising the steps of:
establishing, by the CPU, a connection between the computer system and the RFID device associated with the product;
receiving, by the CPU, product data transmitted by RFID device;
further receiving, by the CPU, visual verification data from the object recognition camera system identifying a quantity of the product selected for the sale;
calculating, by the CPU, a total cost of the sale as a function of the product data and the quantity identified by the object recognition camera system; and
billing, by the CPU, the total cost of the sale automatically to an account accessible by the computer system.

9. The system of claim 8, further performing the steps of:
compiling, by the CPU, an electronic receipt reciting each product billed to the account accessible by the computer system; and
displaying, by the CPU, the electronic receipt.

10. The system of claim 8, further comprising:
a sensor device electronically communicating with the CPU;
receiving, by the CPU, sensor data from the sensor device; and
determining, by the CPU, the quantity of product selected for the sale as a function of the sensor data and product data.

11. The system of claim 10, further performing the step of:
comparing, by the CPU, the quantity of the product selected as a function of the sensor data to the quantity of the product selected as a function of the visual verification data; and
verifying, by the CPU, that the quantity of the of the product selected as a function of the sensor data is equal to the quantity of the product selected as a function of the visual verification data.

12. The system of claim 8, further performing the step of:
transmitting, by the CPU, a request for assistance upon receiving the product data transmitted by RFID device to the CPU.

13. The system of claim 12, further performing the steps of:
storing, by the CPU, visual verification data as video data confirming completion of the sale; and
displaying, by the CPU, the video data on a display device coupled to the CPU.

14. The system of claim 8, wherein the RFID device is a near field communication (NFC) device connecting to the CPU as a function of the distance between the NFC device and computer system.

15. A computer program product comprising:
a computer-readable storage device; and
a computer-readable program code stored in the computer-readable storage device, the computer-readable program code comprising instructions executed by a central processing unit (CPU) of a computer system implementing a method for automating a point of sale system comprising the steps of:
establishing, by the CPU, a connection between the computer system and the RFID device associated with the product;
receiving, by the CPU, product data transmitted by RFID device;
further receiving, by the CPU, visual verification data from the object recognition camera system identifying a quantity of the product selected for the sale;
calculating, by the CPU, a total cost of the sale as a function of the product data and the quantity identified by the object recognition camera system; and
billing, by the CPU, the total cost of the sale automatically to an account accessible by the computer system.

16. The computer program product of claim 15, further performing the steps of:
compiling, by the CPU, an electronic receipt reciting each product billed to the account accessible by the computer system; and
displaying, by the CPU, the electronic receipt.

17. The computer program product of claim 15, further performing the steps of:
connecting, by the CPU, the computer system to a sensor device; and
receiving, by the CPU, sensor data from the sensor device; and
determining, by the CPU, the quantity of product selected for the sale as a function of the sensor data and product data.

18. The computer program product of claim 15, further performing the step of:
transmitting, by the CPU, a request for assistance upon receiving the product data transmitted by RFID device to the CPU.

19. The computer program product of claim 18 further performing the steps of:
storing, by the CPU, visual verification data as video data confirming completion of the sale; and
displaying, by the CPU, the video data.

20. The computer program product of claim 15, wherein the RFID device is a near field communication (NFC) device connecting to the computer system as a function of the distance between the NFC device and computer system.
